(19) United States
(12) Patent Application Publication
(10) Pub. No.: US 2009/0059716 A1
(43) Pub. Date: Mar. 5, 2009

(54) Method of applying raw materials

(75) Inventors: Makoto Katsumata, Susono (JP); Yukihiro Masuda, Susono (JP)

Correspondence Address: Edwards Angell Palmer & Dodge LLP, P.O. Box 55874, Boston, MA, 02205, US

(73) Assignee: Yazaki Corporation, Tokyo (JP)

(21) Appl. No.: 12/216,786

(22) Filed: Jul. 10, 2008

(30) Foreign Application Priority Data
Aug. 28, 2007 (JP) 2007-220473

(51) Int. Cl. B01F 15/04

(52) U.S. Cl. 366/141

(57) ABSTRACT

For providing a method of applying raw materials capable to make control of manufacturing easier and to make a compound stable in quality, firstly each raw materials is respectively measured. Secondly, by packing each of the raw materials with each determinate quantity in a packed form of each bag, each pack of raw material can be given. Preparing each of the required numbers of the packs of raw material corresponding to each of required quantities of the raw materials, the prepared packs of raw material are supplied into a mixing-tempering machine 31. Thereafter, the mixing-tempering and pelleting processes will be acted, and the compound stable in quality can be provided.

The priority application Number Japan Patent Application 2007-220473 upon which this patent application is based is hereby incorporated by reference.

### BACKGROUND OF THE INVENTION

1. Field of the Invention

This invention relates to a method of continuously mixing and tempering a resin compound, especially, a method of applying plural kinds of raw materials quantitatively into a mixing-tempering machine.

2. Description of the Related Art

In a process of continuously mixing and tempering raw materials, a measuring apparatus by volumetric method or a measuring apparatus by weighing method is used for measuring and applying the raw materials. According to the measuring apparatus by volumetric method, a process includes the steps of rotating a screw-feeder in a low speed, measuring materials with a predetermined volume thereby, and applying the measured materials into a mixing-tempering machine. According to the measuring apparatus by weighing method, a process includes the steps of detecting a supplying weight of the raw material by a load cell, controlling a motor for applying the detected raw materials by informing the supplying weight of the raw materials, and applying the raw materials with a predetermined weight into a mixing-tempering machine (refer Japan Patent Published Application No. H06-71640).

### SUMMARY OF THE INVENTION

### Objects to be Solved

According to the measuring apparatus by volumetric method, since the measuring the raw materials is controlled by a volume of the raw material, measuring accuracy is depended on an apparent specific gravity, so that it causes that manufacturing may have difficulties in control (it means that feed-back control could not follows changes: when various materials with different specific gravity, controlling a rotating speed is acted frequently by the feed-back so that the controlling could not follows the changes).

According to the measuring apparatus by weighing method, since the load cell is generally fragile against a shock from outside, measuring accuracy is influenced by a shock by applying materials or by acting a material feeder, so that it causes that quality of a resin compound would be unstable (a vibration caused by biting the raw materials is generated by rotation or vibration when feeding raw materials).

### How to Attain the Object of the Present Invention

According to the above problems, an object of the present invention is to provide a method of applying raw materials, which can make manufacturing easy in control and stabilize quality of compounds.

In order to overcome the above problems and attain the object of the present invention, a method of applying raw materials according to the present invention is characterized of including the steps of preparing a pack of each of the raw materials with each determinate quantity in a packed form by measuring each of the raw materials and packing it respectively with the each determinate quantity in preparing processes; and applying each required number of the packs of each of the raw materials with the each determinate quantity prepared in the packed form to the mixing-tempering machine.

In order to overcome the above problems, a further method of applying raw materials according to the present invention is characterized of including the steps of preparing a pack of a blended material with a determinate quantity in a packed form by measuring each of the raw materials and blending measured materials and packing the blended material with the determinate quantity in preparing processes; and applying required number of the packs of the blended material prepared in the packed form to the mixing-tempering machine.

According to the present invention having the above features, the raw materials can be applied quantitatively into the mixing-tempering machine. The compounds to be used, which is given by applying the raw materials quantitatively and mixing and tempering it, can be stable in quality.

### Effects of the Invention

According to the method of applying the raw materials of the present invention, manufacturing it can be controlled easer than usual, and quality of the compounds can be stabilized more than usual.

The above and other objects and features of this invention will become more apparent from the following description taken in conjunction with the accompanying drawings.

### BRIEF DESCRIPTION OF THE DRAWINGS

FIGS. 1A-1G are illustrations of an embodiment of a method of applying raw materials according to the present invention; and

FIGS. 2A-2G are illustrations of another embodiment of a method of applying raw materials according to the present invention.

### DESCRIPTION OF THE PREFERRED EMBODIMENT

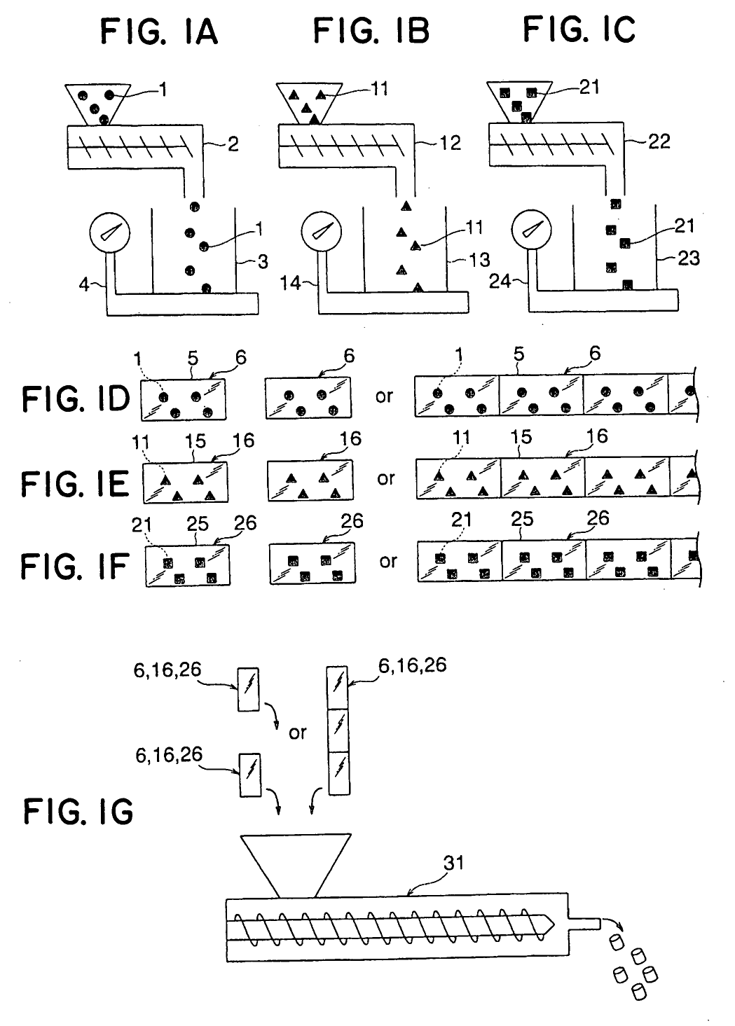

With reference to figures, a method of applying raw materials according to the present invention will be described. FIGS. 1A-1G show a process of the steps by an embodiment of the method of applying raw materials according to the present invention. In the embodiment, three raw materials are shown by way of example. The method according to the present invention is not limited in the embodiment.

Firstly, in FIGS. 1A, 1B, 1C, the method of applying raw materials according to the present invention includes a step of measuring respectively each of raw materials. Secondly, by packing each of the raw materials with each determinate quantity in a packed form of a bag or a container, a pack of each of the raw materials can be given. The above steps are acted in preparing processes. Each required number of packs of each of the raw materials with each determinate quantity is prepared and applied with the packed form into a mixing-tempering machine. Since plural kinds of raw materials are applied quantitatively into the mixing-tempering machine, mixed, tempered and formed into a pellet shape, a compound made of the raw materials can be given in stable quality. The method according to the present invention will be described more in detail.

In FIG. 1A, a raw material 1 is supplied from a material supply device 2 to a measuring tray 3. The raw material 1 is measured by a measuring apparatus 4 during being supplied into the measuring tray 3. When the raw material 1 is accumulated with a determinate quantity, the accumulated raw material 1 is packed in a bag 5 to become a pack of raw material 6 with the determinate quantity, as shown in FIG. 1D.

The bag 5 can be formed into a respective bag or into continuous bags as shown in FIG. 1D. The bag 5 is made of a thermoplastic resin and the bag 5 is sealed by welding. The bag 5 may be made of a transparent material to see the raw material 1 inside thereof.

A process from supplying raw materials 1 to packing the packs of raw material 6 is acted until a required number of the packs of raw material 6 corresponding to a quantity of a compound to be used is reached. This process is done as a preparing process before later-described mixing-tempering and pelleting processes.

In FIGS. 1B and 1C, each of raw materials 11 and 21, similarly as the raw material 1, is supplied from each of material supply devices 12, 22 to each of measuring trays 13, 23. Each of the raw materials 11, 21 is measured by each of measuring apparatuses 14, 24 during being supplied into each of the measuring trays 13, 23. When each of the raw materials 11, 21 is accumulated with each determinate quantity, each of the accumulated raw materials 11, 21 is packed in each of bags 15, 25 to become respectively packs of raw material 16, 26 with each determinate quantity, as shown in FIGS. 1E, 1F.

The bags 15, 25 can be formed into a respective bag or into continuous bags as shown in FIGS. 1E, 1F. The bags 15, 25 are made of a thermoplastic resin and the bags 15, 25 are sealed by welding. The bags 15, 25 maybe made of a transparent material to see the raw materials 11, 21 inside thereof.

Each of processes from supplying raw materials 11, 21 to packing the packs of raw material 16, 26 is acted until each of required numbers of the packs of raw material 16, 26 is reached. These processes are done as the preparing process before the later-described mixing-tempering and pelleting processes.

In FIG. 1G, preparing each of the required numbers of the packs of raw material 6, 16, 26 corresponding to each of required quantities of the raw materials 1, 11 and 21, the prepared packs of raw material 6, 16; 26 are supplied with the packed form into a mixing-tempering machine 31. Thereafter, the mixing-tempering and pelleting processes will be acted.

According to the present invention, the raw materials 1, 11, 21 are supplied quantitatively into the mixing-tempering machine 31. The compound to be used, which is given by quantitatively supplying the raw materials 1, 11, 21, and by mixing and tempering them, is made stable in quality. According to the present invention, an accuracy of measuring the raw materials is not depended on an apparent specific gravity of each raw material 1, 11, 21, so that manufacturing can be controlled easily more than usual.

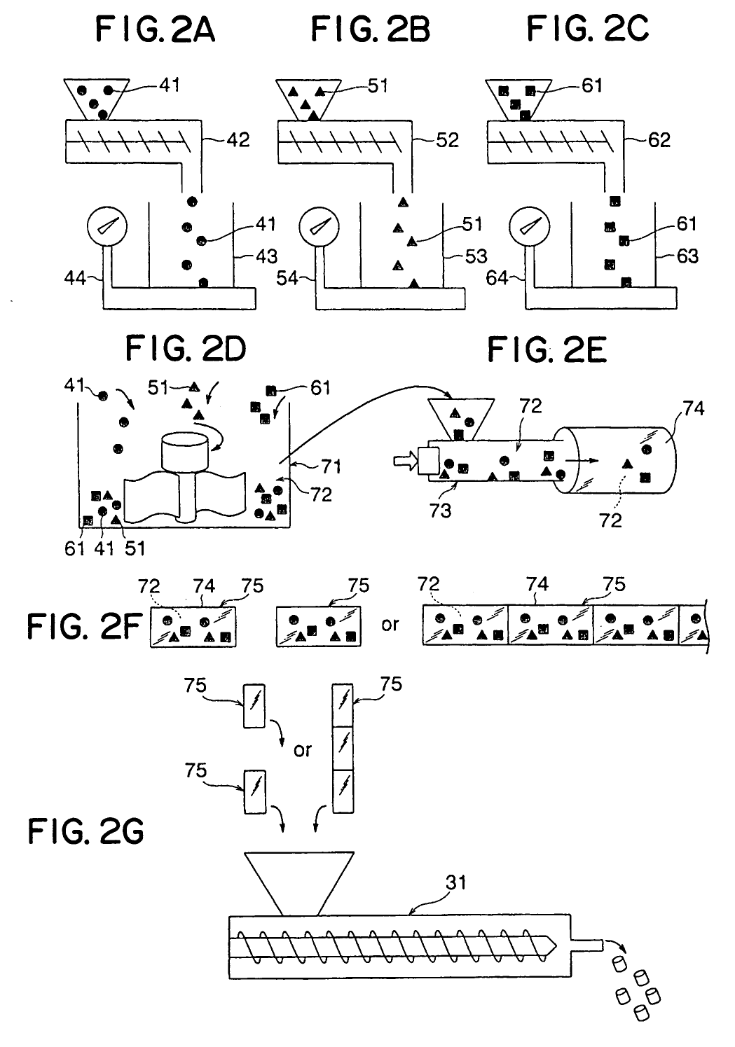

With reference to FIGS. 2A-2G, another embodiment of the method of applying raw materials according to the present invention will be described. FIGS. 2A-2G are illustrations of the another embodiment for showing processes of applying raw materials.

Firstly, in FIGS. 2A, 2B, 2C, the method of applying raw materials according to the present invention includes a step of measuring respectively each of raw materials. Secondly, by blending the measured raw materials and packing the blended material with a determinate quantity in a packed form of a bag or a container, a pack of the blended material can be given. The above steps are acted in preparing processes. A required number of packs of the blended materials with the determinate quantity is prepared and applied into a mixing-tempering machine. Since plural kinds of raw materials are applied quantitatively into the mixing-tempering machine, mixed, tempered and formed into a pellet shape, a compound made of the raw materials can be given in stable quality. The method according to the present invention will be described more in detail.

In FIG. 2A, a raw material 41 is supplied from a material supply device 42 to a measuring tray 43. The raw material 41 is measured by a measuring apparatus 44 during being supplied into the measuring tray 43. When the raw material 41 is accumulated with a determinate quantity required for blending a compound, the accumulated raw material 41 is putted into a blending machine 71 as shown in FIG. 2D.

In FIGS. 2B and 2C, each of raw materials 51 and 61, similarly as the raw material 41, is supplied from each of material supply devices 52, 62 to each of measuring trays 53, 63. Each of the raw materials 51, 61 is measured by each of measuring apparatuses 54, 64 during being supplied into each of the measuring trays 53, 63. When each of the raw materials 51, 61 is accumulated with each determinate quantity required for blending the compound, each of the accumulated raw materials 51, 61 is putted into a blending machine 71 as shown in FIG. 2D.

The raw materials 41, 51, and 61 are blended in the blending machine 71 and become to a blended material 72 after blending enough. The blended material 72 is supplied to a packing machine 73 as shown in FIG. 2E. In the packing machine 73, the blended material 72 is packed in a bag 74 to become a pack of blended material 75 with a determinate quantity, as shown in FIG. 2F.

The bag 74 can be formed into a respective bag or into continuous bags as shown in FIG. 2F. The bag 74 is made of a thermoplastic resin and the bag 74 is sealed by welding. The bag 74 may be made of a transparent material to see the blended material 72 inside thereof.

A process from supplying raw materials 41, 51, 61 to packing the packs of blended material 75 is acted until a required number of the packs of blended material 75 corresponding to a quantity of a compound to be used is reached. This process is done as a preparing process before later-described mixing-tempering and pelleting processes.

In FIG. 2G, preparing the required number of the packs of blended material 75 corresponding to required quantity of the blended material to be used, the prepared packs of blended material 75 are supplied with the packed form into the mixing-tempering machine 31. Thereafter, the mixing-tempering and pelleting processes will be acted.

According to the present invention, the raw materials 41, 51, 61 in the form of the pack of blended material 75 are supplied quantitatively into the mixing-tempering machine 31. The compound to be used, which is given by supplying the pack of blended material 75 and by mixing and tempering them, is made stable in quality. According to the present invention, an accuracy of measuring the raw materials is not depended on an apparent specific gravity of each raw material 41, 51, 61, so that manufacturing can be controlled easily more than usual.

Various change and modifications can be made with the scope of the present invention.

The bags 5, 15, 25, 58 are made of a material, which has no influence on quality of compounds by supplying together into the mixing-tempering machine 31.

1. A method of applying raw materials to apply quantitatively plural kinds of raw materials to a mixing-tempering machine, comprising the steps of:
preparing a pack of each of the raw materials with each determinate quantity in a packed form by measuring each of the raw materials and packing it respectively with the each determinate quantity in preparing processes; and
applying each required number of the packs of each of the raw materials with the each determinate quantity prepared in the packed form to the mixing-tempering machine.

2. A method of applying raw materials to apply quantitatively plural kinds of raw materials to a mixing-tempering machine, comprising the steps of:
preparing a pack of a blended material with a determinate quantity in a packed form by measuring each of the raw materials and blending measured materials and packing the blended material with the determinate quantity in preparing processes; and
applying required number of the packs of the blended material prepared in the packed form to the mixing-tempering machine.
